(19) United States
(12) Patent Application Publication
(10) Pub. No.: US 2014/0370894 A1
(43) Pub. Date: Dec. 18, 2014

(54) PUBLIC LAND MOBILE NETWORK RESOLUTION IN A SHARED NETWORK AND A DEDICATED NETWORK

(71) Applicant: NOKIA SIEMENS NETWORKS OY, Espoo (FI)

(72) Inventors: Santhosh Kumar HOSDURG, Dunwoody, GA (US); Krishnan IYER, Dunwoody, GA (US); Miguel Machado COSTA, Munich (DE)

(73) Assignee: NOKIA SIEMENS NETWORKS OY, Espoo (FI)

(21) Appl. No.: 13/918,296

(22) Filed: Jun. 14, 2013

(51) Int. Cl. H04W 36/00; H04W 36/08

(52) U.S. Cl. CPC H04W 36/0077; H04W 36/08
USPC 455/436

(57) ABSTRACT

Certain embodiment relate to public land mobile network resolution in a shared and a dedicated network. The method may include receiving, at the serving base station, a handover restriction list (HRL) comprising information on serving public land mobile networks (PLMN) or equivalent public land mobile networks (EPLMN) of the user equipment. The method may also include receiving a PLMN list comprising a plurality of PLMNs that are hosted by the target base station. The method may further include selecting a target PLMN for the user equipment using the HRL and the PLMN list, wherein the selected target PLMN is on the PLMN list but is not on the HRL. The method may also include sending a handover request message indicating the selected target PLMN for the user equipment to the target base station.

### BACKGROUND

1. Field

Certain embodiments relate to communication systems, such as third generation partnership project (3GPP) and long term evolution (LTE). More particularly, certain embodiments relate to a method and apparatus for serving a public land mobile network (PLMN) resolution during multi-operator core network (MOCN)/shared and dedicated network environment involving multiple partner hosting which may utilize evolved-universal terrestrial radio access network (EUTRAN), inter public land mobile network (PLMN) handover (HO) either via S1 or X2 application protocols, automatic neighbor relation (ANR), self-optimizing network (SON), etc.

2. Description of the Related Art

In mobile networks, a handover restriction list (HRL) information element (IE) defines area roaming or access restrictions for subsequent mobility action for which the evolved Node B (eNB) provides information about the target of the mobility action towards the user equipment (UE), for example, handover (HO) and cell change order (CCO). According to current 3GPP 36.413 specification, whenever an eNB receives the handover restriction list, it shall overwrite previously received HRL information. In other words, the target eNB proceeds with roaming to targets all indicated in the handover restriction list received.

Further, with an inter PLMN handover between a dedicated LTE network and a shared LTE network in a multi-operator core network (MOCN) configuration, the source eNB is not able to continue the handover while the target selected PLMN is not included in the UE HRL IE, although still broadcasted by the target eNB. The 3GPP standards also do not address this particular use case scenario.

According to current 3GPP specification, the handover required message or handover request message (HRM) may be processed only if the target selected PLMN is included in UE HRL.

Accordingly, the source eNB located within a dedicated LTE network is not able to or does not know how to proceed with processing the HRM when the dedicated LTE network's eNB does not know if the handover to the target selected PLMN is even allowed.

### SUMMARY

According to a first embodiment, a method for handing over a user equipment from a serving base station in a dedicated network to a target base station in a shared network, where the method may include receiving, at the serving base station, a handover restriction list (HRL) comprising information on serving public land mobile networks (PLMN) or equivalent public land mobile networks (EPLMN) of the user equipment. The method may also include receiving a PLMN list comprising a plurality of PLMNs that are hosted by the target base station. The method may further include selecting a target PLMN for the user equipment using the HRL and the PLMN list. The selected target PLMN is on the PLMN list but is not on the HRL. The method may also include sending a handover request message indicating the selected target PLMN for the user equipment to the target base station.

According to a second embodiment, an apparatus for handing over a user equipment from a dedicated network to a target base station in a shared network, where the apparatus may include at least one processor and at least one memory including computer program code, where the at least one memory and the computer program code are configured to, with the at least one processor, cause the apparatus at least to receive a handover restriction list (HRL) comprising information on serving public land mobile networks (PLMN) or equivalent public land mobile networks (EPLMN) of the user equipment. The at least one memory and the computer program code may also cause the apparatus to receive a PLMN list comprising a plurality of PLMNs that are hosted by the target base station. The at least one memory and the computer program code may also cause the apparatus to select a target PLMN for the user equipment using the HRL and the PLMN list. The selected target PLMN is on the PLMN list but is not on the HRL. The at least one memory and the computer program code may also cause the apparatus to send a handover request message indicating the selected target PLMN for the user equipment to the target base station.

According to a third embodiment, a computer program embodied on a computer-readable medium, the computer program may be configured to control a processor to perform operations including receiving, at a serving base station, a handover restriction list (HRL) comprising information on serving public land mobile networks (PLMN) or equivalent public land mobile networks (EPLMN) of a user equipment. The computer program may also be configured to control a processor to perform operations including receiving a PLMN list comprising a plurality of PLMNs that are hosted by a target base station. The computer program may be further configured to control a processor to perform operations including selecting a target PLMN for the user equipment using the HRL and the PLMN list, wherein the selected target PLMN is on the PLMN list but is not on the HRL. The computer program may also be configured to control a processor to perform operations including sending a handover request message indicating the selected target PLMN for the user equipment to the target base station.

### BRIEF DESCRIPTION OF THE DRAWINGS

For proper understanding of the invention, reference should be made to the accompanying drawings, wherein:

FIG. 1 illustrates a dedicated and shared LTE network according to certain embodiments.

FIG. 2 illustrates a flowchart of handover decision logic for an eNB according to certain embodiments.

FIG. 3 illustrates a flowchart of handover decision logic for a dedicated and a shared LTE network according to certain embodiments.

FIG. 4 illustrates a dedicated and shared LTE network for building a PLMN Selection List according to certain embodiments.

FIG. 5 illustrates a flowchart of handover decision logic for a dedicated and a shared LTE network according to certain embodiments.

FIG. 6 illustrates a network system according to certain embodiments.

### DETAILED DESCRIPTION

Certain embodiments are related to inter PLMN handover between dedicated long term evolution (LTE) networks and a shared LTE network in a multi-operator core network (MOCN) configuration, while a target selected cell is supporting multiple broadcast PLMNs. In the MOCN approach, the shared evolved-universal terrestrial radio access network (eUTRAN) is connected to several core networks (CNs) such as the evolved packet core (EPC) via the Si interface, and one cell can be used by multiple operators' core networks. In this regard, multiple PLMNs may be available for each shared LTE network's evolved-Node B (eNB).

A single shared LTE network's eNB may, therefore, broadcast a list of multiple PLMN IDs in the same cell. The first entry of the PLMN list may be referred to as a primary PLMN in air interface, which is included in several identifiers such as eUTRAN cell global ID (ECGI), and Global eNB ID, etc. The shared LTE network's eNBs behave based on the assumption that a CN such as EPC is configured to perform routing via a primary PLMN of a target cell. In other words, routing can be based on ECGI (which is based on Primary PLMN ID). Also, routing can be based on Global eNB ID.

An inter PLMN handover procedure can be initiated through a mobility management entity (MME) by sending a handover required message (in case of S1 HO) or a handover request message (in case of X2 HO) to the target eNB. The handover required message or the handover request message can contain a handover restriction list (HRL) information element (IE), which contains the serving PLMN and can contain equivalent PLMNs (EPLMNs), and roaming area or access restrictions.

Most LTE network operators do not have enough radio resource spectrum to meet their subscriber data demand. The LTE network operator who has an abundance of spectrum often realizes their business goals by sharing their spectrum with other operators who lack spectrum.

One effective way for an operator to share its spectrum with multiple partner networks/operators is by operating their eUTRAN network in MOCN configuration mode, thus enabling eUTRAN sharing. Another approach involves an operator hosting multiple partners' PLMNs. These networks are referred to as shared networks.

Partners who own and operate their own LTE network without sharing are often referred to as dedicated networks or conventional networks. Usage of both a dedicated network and a shared network results in a heterogeneous network scenario.

Mobility across such a heterogeneous network poses unique challenges which are not currently addressed in 3GPP standards. Mobility challenges between the dedicated LTE network and the shared LTE network of an operator may need to be addressed for efficient usage of the dedicated and shared network spectrum. These deployments can often lend to a network overlay scenario for improving capacity or for coverage reasons.

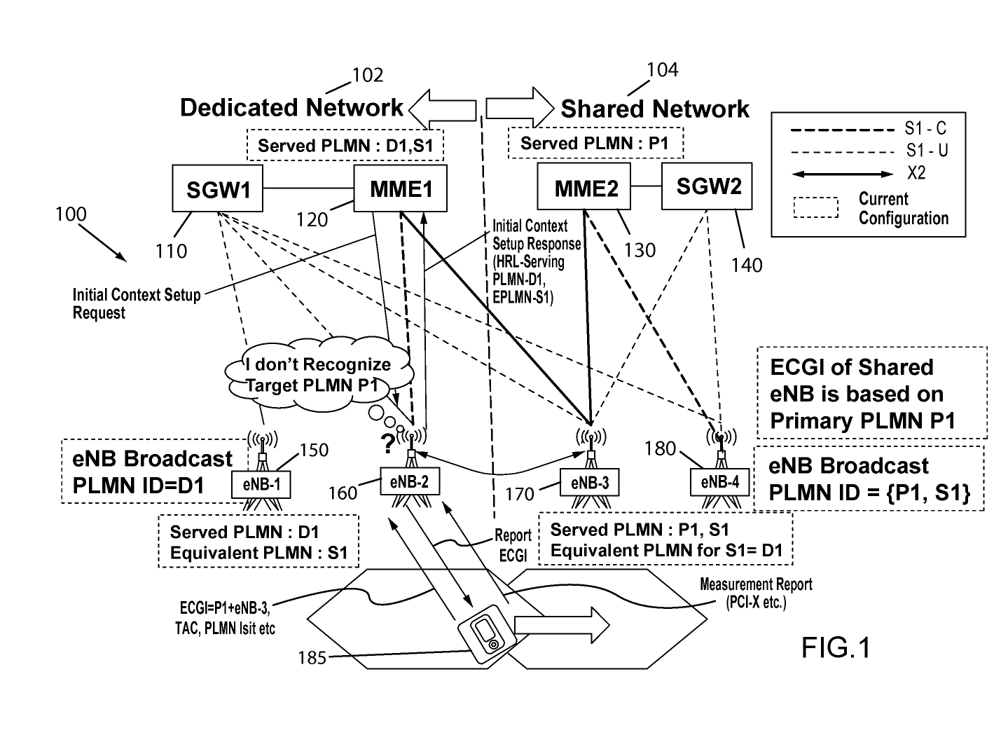

FIG. 1 illustrates a dedicated and a shared LTE network 100 according to certain embodiments. FIG. 1 shows serving gateway (SGW) 110, mobility management entity (MME) 120, evolved Node B (eNB) 150, and source eNB 160 in dedicated LTE network 102 and MME 130, SGW 140, target eNB 170, and eNB 180 in shared LTE network 104.

In dedicated network 102, eNB 150 and source eNB 160 are serving primary PLMN D1. Dedicated network 102 includes an EPC which may include MME 110 and SGW 120 and serves eNB 150, source eNB 160, and PLMN D1. An operator of dedicated network 102 may plan to use shared PLMN-S1 for excess capacity/coverage reasons; therefore, shared PLMN S1 may be served by the EPC of dedicated network 102, the EPC may include MME 110 and SGW 120. PLMN-S1 may be defined as an equivalent public land mobile network (EPLMN) to PLMN-D1 in MME 120 of dedicated network 102. Thus, EPLMN can be defined as part of an MME configuration.

Shared network 104, target eNB 170, and eNB 180 can serve primary PLMN-P1 and a shared PLMN-S1. Primary PLMN-P1 of MOCN (target) eNB 170 and eNB 180 are served by the EPC of shared network 104 which includes MME 130 and SGW 140.

The UEs 185 associated with dedicated network 102 may have a handover restriction list (HRL), for example, PLMN-D1 and S1. The operator of shared network 104 may have PLMN-P1 as serving PLMN. When UE 185 of dedicated network 102 is in serving PLMN-D1, the HRL may have serving PLMN-D1, EPLMN-S1 listed. When UE 185 of dedicated network 102 is in shared network 104, the HRL may have serving PLMN-S1, EPLMN-D1 listed. Further, the primary PLMN-P1 cannot be defined as EPLMN for PLMN ID (D1 or S1) as it belongs to a main operator of shared network 104 and connects to its own independent EPC including MME 130 and SGW 140.

In the case of mobility from source eNB 160 belonging to dedicated network 102 to target eNB 170 belonging to shared network 104 in MOCN configuration, hosting multiple PLMNs, the following challenges may exist: UE 185 of an operator in dedicated network 102, in PLMN-D1, measures a target physical cell ID (PCI) of target eNB 170 in shared network 104 and reports the target PCI to the serving source eNB 160 in dedicated network 102, PLMN-D1. If the target PCI cannot be resolved by source eNB 160 of dedicated network 102, then source eNB 160 may request UE 185 for the ECGI reporting. UE 185 may send the target cell an enhanced cell global identity (ECGI) defined as P1+ target eNB 170, tracking area code (TAC) and PLMN list S1 supported by the target cell. TAC is common to all the broadcast PLMNs of the target eNB 170 in shared network 104. UEs 185 serving eNB 160, do not have any information about primary PLMN-P1 of shared network 104 and eNB 170 and may not initiate self-optimizing network (SON) related procedure to resolve the target eNB transport network layer (TNL).

Additional challenges may exist, for example, even if an X2 link is already setup between source eNB 160 and target eNB 170, then source eNB 160 may not attempt handover to target PLMN-P1 as source eNB 160 cannot be resolved using the HRL information available for UE 185. Also, primary PLMN-P1 of target eNB 170 may not be in the HRL information associated with UE 185 of the operator of dedicated network 102. Further, in the case of non-availability of X2 due to the above mentioned scenario, even the S1 handover cannot be initiated as source eNB 160 cannot resolve target PLMN-P1 despite the fact that the target cell serves PLMN-S1 which is EPLMN to UEs 185 serving PLMN-D1.

Also, it should further be noted that a handover target cell may only be considered as allowed handover target if it broadcasts a PLMN-ID which is either the UE's serving PLMN-ID or contained in the UE's HRL within equivalent PLMN list Information Element.

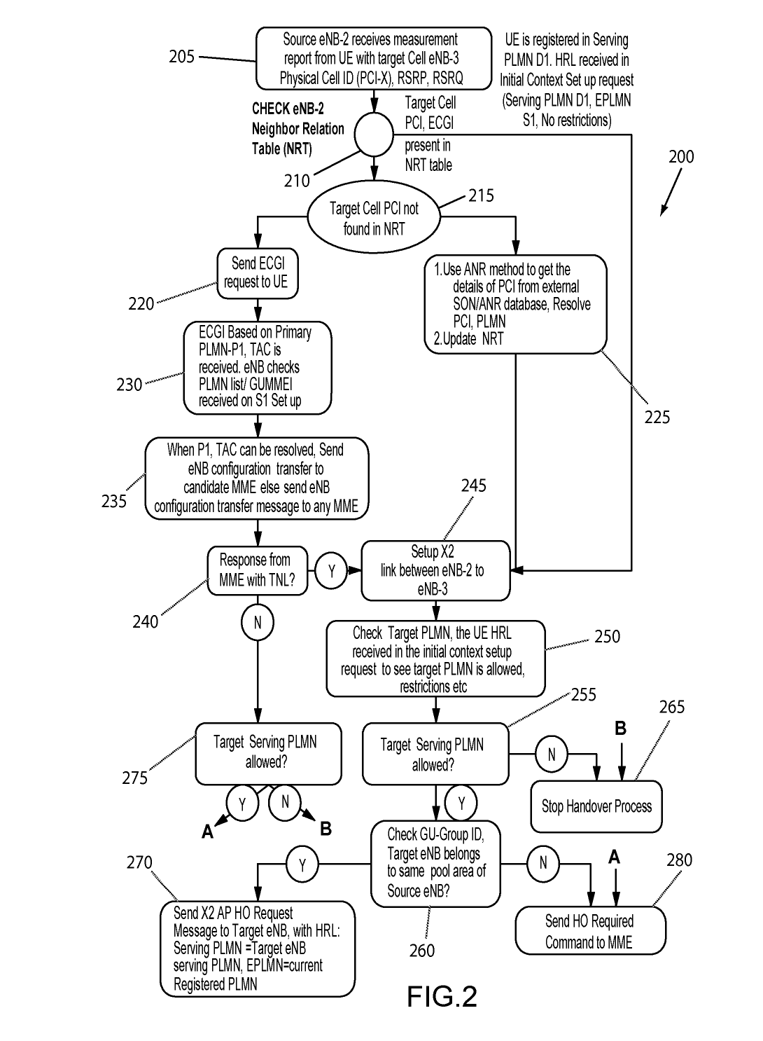

FIG. 2 illustrates a flowchart 200 of handover decision logic for an eNB according to certain embodiments. FIG. 2 shows a decision flow graph in a source eNB, involved during a handover scenario. UE 185 is registered in serving PLMN-D1 and HRL is received in initial context set up request and may indicate the serving PLMN-D1, EPLMN-S1, no restrictions, etc.

At 205, source eNB 160 receives a measurement report from UE 185 with target cell eNB 170's physical cell ID (PCI-X), Reference Signal Received Power (RSRP), and Reference Signal Received Quality (RSRQ). At 210, source eNB 160 is checked via neighbor relation table (NRT) for target cell PCI, enhanced cell global identity (ECGI) being present in the NRT table. At 215, the target cell PCI is not found in the NRT. At 220, an ECGI request is sent to UE 185. At 225, optionally an automatic neighbor relation (ANR) method is utilized to get the details of PCI from an external SON/ANR database to resolve PCI, PLMN. Next, the NRT is updated. At 230, an ECGI based on primary PLMN-P1, TAC is received and eNB checks the PLMN list/global unique mobility management entity (GUMMEI) received on 51 set up. At 235, upon resolving the P1, TAC, an eNB configuration transfer is sent to candidate MME else an eNB configuration transfer message may be sent to any MME. At 240, if there is a response from MME with Transport Network Layer (TNL), then at 245, an X2 link is setup between source eNB 160 to target eNB 170. Otherwise, at 275, if target serving PLMN is allowed, then the logic proceeds to 280 and a handover required command is sent to MME, or if target serving PLMN is not allowed, then the logic proceeds to 265 and the handover process is stopped. At 250, the target PLMN is checked and the UE HRL is received in the initial context setup request is checked to see if target PLMN is allowed or has restrictions, etc. At 255, if target serving PLMN is allowed, then at 260, the GU-Group ID is checked to see whether target eNB belongs to same pool area of source eNB. Otherwise, at 265, the handover process is stopped if the target serving PLMN is not allowed. At 270, if the GU-Group ID and target eNB 170 belong to the same pool area of source eNB 160, then an X2 application protocol (AP) handover request message is sent to target eNB 170, with HRL serving PLMN=target eNB 170 serving PLMN, EPLMN=current registered PLMN. Otherwise, at 280, a handover required command is sent to MME.

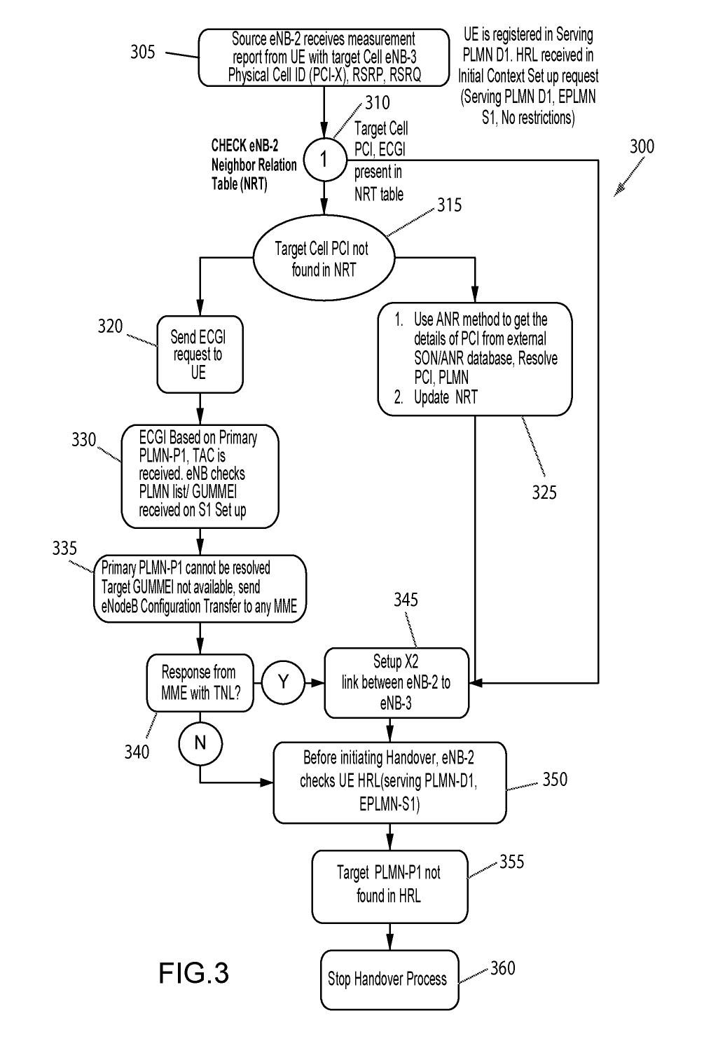

FIG. 3 illustrates a flowchart 300 of handover decision logic for a dedicated and a shared LTE network according to certain embodiments. FIG. 3 illustrates why the handover fails in source eNB 160 in the scenario described above. It can be seen that the target PLMN-P1 cannot be resolved in source eNB 160 to initiate handover process although target eNB 170 serves both PLMN-P1, PLMN-S1 and PLMN-S1 being EPLMN to UE's current serving PLMN-D1. UE 185 is registered in serving PLMN-D1 and HRL is received in initial context set up request and may indicate the serving PLMN-D1, EPLMN-S1, no restrictions, etc.

At 305, source eNB 160 receives a measurement report from UE 185 with target cell's target eNB 170 physical cell ID (PCI-X), Radio Signal Receive Power (RSRP), and Reference Signal Received Quality (RSRQ). At 310, source eNB 160 is checked via neighbor relation table (NRT) for target cell PCI, ECGI being present in the NRT table. At 315, the target cell PCI is not found in the NRT. At 320, an ECGI request is sent to UE 185. At 325, optionally an automatic neighbor relation (ANR) method is utilized to get the details of PCI from an external SON/ANR database to resolve PCI, PLMN. Next, the NRT is updated. At 330, an ECGI based on primary PLMN-P1, TAC is received and source eNB 160 checks the PLMN list/global unique mobility management entity (GUMMEI) received on S1 set up. At 335, the primary PLMN-P1 cannot be resolved and target GUMMEI is not available, therefore, an eNB configuration transfer message is sent to any MME. At 340, if there is a response from MME with transfer network layer (TNL), then at 345, an X2 link is setup between source eNB 160 to target eNB 170. Otherwise, then at 350, before initiating handover, source eNB 160, the UE HRL serving PLMN-D1, EPLMN-S1 is checked. At 355, if target PLMN P1 is not found in HRL, then at 360, the handover process is stopped.

The above mentioned problems can be addressed, provided the primary PLMN-P1 and the shared PLMN-S1 can be associated in eNB 150 and source eNB 160 of dedicated network 102, such that UE 185 can be handed over from dedicated PLMN-D1 to shared PLMN-S1.

Certain embodiments address how a logical association between primary PLMN-P1 and shared PLMN-S1 can be achieved using HRL information of UE 185 and PLMN list of target eNB 170, for example, via the PLMN selection list, thereby deriving target PLMN-S1 to be used for handover to target cell (target eNB 170). Further, certain embodiments are fully backward compatible and would not impact existing functionality.

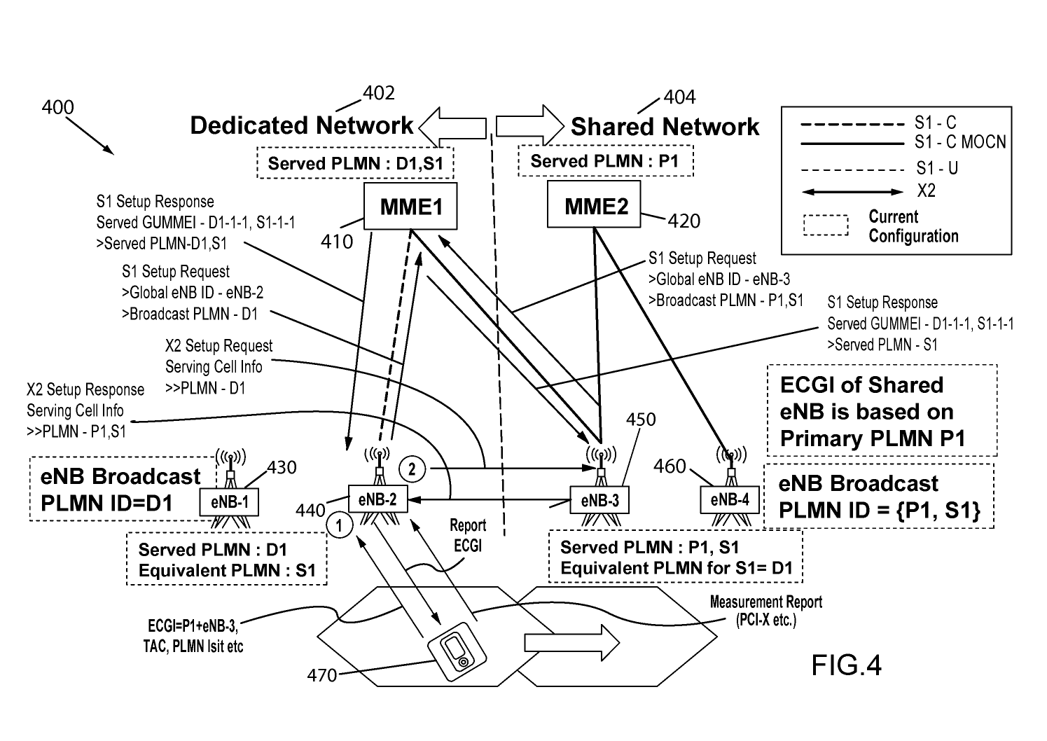

FIG. 4 illustrates a dedicated and a shared LTE network 400 for building a PLMN selection list according to certain embodiments. In FIG. 4 certain embodiments provide a solution to ensure a successful handover from dedicated LTE network 402 to shared LTE network 404 when a target selected PLMN is not included in the HRL of UE 470. Dedicated network 402 includes MME 410, eNB 430 and source eNB 440. Shared network 404 includes MME 420, target eNB 450 and eNB 460. In particular, certain embodiments provide a solution to identify or determine if a target eNB 450 in shared network 404 is allowed to handle or proceed with a handover from dedicated LTE network 402 to shared LTE network 404 for a target selected PLMN that is not included in the HRL of UE 470. In addition, certain embodiments provide a solution on how to select the target PLMN not included in the HRL of UE 470, in connection with a correct target eNB 450 serving or primary PLMN in the eNBs of dedicated LTE network 402. It should be noted that HRL of UE 470 can be stored in source eNB 440, not in UE 470 itself.

In this regard, certain embodiments introduce a new parameter called target PLMN selection list for use along with the HRL of UE 470 to resolve the target selected PLMN for handovers evaluation. For example, the target PLMN selection list may be used in the following order when available to derive target PLMN using: (1) PLMN list reported by UE as part of ECGI reporting and (2) PLMN list exchanged between source eNB 440 and target eNB 450, such as in the case when X2 is setup. Also, other orders/sequences may fall within the scope of various embodiments.

The target selected PLMN in the source eNB 440 in dedicated LTE network 402 may be derived from following formula:

Target PLMN={(PLMN Selection LIST of Target eNB) ∩(Serving PLMN, EPLMN, in HRL of UE)} (1)

where, “PLMN Selection List” of target eNB 450 can be obtained, for example, when source eNB 440 receives target ECGI and target cell broadcast PLMNs as part of ECGI measurement report or when X2 link is setup between source eNB 440 and target eNB 450. In terms of precedence, when reported, the PLMN list obtained as part of target ECGI resolution may be considered as first choice to resolve the target PLMN. For example, the PLMN list obtained as part of X2 setup between the source eNB 440 and target eNB 450 may be considered as second choice for the target PLMN selection list.

The handover restriction list (HRL) for UE 470 is relayed to source eNB 440 during the initial context setup procedure as part of an attach process as shown FIG. 1.

Certain embodiments enable continuing a handover procedure from dedicated LTE network 402 to shared LTE network 404 when a target selected PLMN is not included in the HRL of UE 470, wherein cells in shared LTE network 404 behave in accordance with a corresponding primary or serving PLMN and a target cell in shared LTE network 404 for the handover is supporting multiple broadcast PLMNs.

In addition, certain embodiments enable using exemplary languages, such as messages/interfaces/protocols in 3GPP specifications to illustrate how certain embodiments may be applied to ensure a successful handover from dedicated LTE network 402 to shared LTE network 404 in a multi-operator core network (MOCN) configuration when a target selected PLMN is not included in the HRL of UE 470, where cells in shared LTE network 404 behave in accordance with a corresponding primary or serving PLMN.

As described above, certain embodiments derive a logical association between PLMN-S1 and primary PLMN-P1 of shared network 404 in order to ensure smooth mobility between these networks. The primary PLMN-P1 cannot be defined as EPLMN for PLMN ID D1 or S1 as it belongs to main operator and connects to its own independent EPC which includes MME 420 and SGW2 (not shown). Mobility agreements between dedicated network 402 and shared network 404 may restrict users of PLMN-P1 from registering or camping in dedicated network 402, PLMN D1, S1.

Therefore, certain embodiments are directed to a unique way of deriving the relationship, that is, the target PLMN between PLMN-P1 and PLMN-S1 for handover using HRL of UE 470 and PLMN selection list of target eNB 450. This is represented in equation (1) above.

In the above case, when UE 470 attaches to the EPC which includes MME 410 in dedicated network 402, source eNB 440 receives the HRL as part of initial context set up message. The HRL of UE 470 may indicate serving PLMN ID=D1 and EPLMN=S1. Now that source eNB 440 has both “PLMN Selection List” and the “HRL of UE 470”, it can derive the target PLMN based on certain embodiments via equation (1).

If the PLMN selection list of target eNB 450 intersection with serving, EPLMN in HRL of UE 470 results in both serving and EPLMN yielding a value, then the intersection result with serving PLMN will take precedence over intersection result with EPLMN.

TABLE 1

| | ECGI Based | | | |
|---|---|---|---|---|
| | on Target | | HRL for | Target PLMN = |
| Information | PLMN | “PLMN | the UE | PLMN Selection |
| Source | (i.e Primary | Selection | (Serving, | List ∩ Serving, |
| at eNB-2 | PLMN) | List” | EPLMN) | EPLMN in HRL |
| Measurement | P1 | P1, S1 | D1, S1 | S1 |
| Report | | | | |
| X2 Setup | P1 | P1, S1 | D1, S1 | S1 |
| Procedure | | | | |

Referring to Table 1 above, source eNB 440 in dedicated network 402 may use the “eNB Configuration Transfer Message” to resolve the TNL address of target eNB 450. Based on the target PLMN 51, derived using techniques described herein, source eNB 440 can now select appropriate GUMMEI to route the eNB configuration transfer message for TNL resolution in the case where the X2 link/interface between source eNB 440 and target eNB 450 is not setup.

The eNB configuration transfer message may have a SON configuration transfer Information Element (IE) which may include: target eNB 450: global eNB ID, selected tracking area identity (TAI)=>target eNB 450, S1+target TAC; and source eNB 440: global eNB ID, selected TAI=>source eNB 440, D1+ serving TAC.

In certain embodiments, if the target eNB 450 has a dedicated X2-IP address, for example, X2-C IP1 for PLMN-P1 and X2-C IP2 for PLMN-S1, for its MOCN partner, the target selected TAI, such as S1+Target TAC value composed by source eNB 440 helps target eNB 450 to resolve the MME configuration transfer message to provide an X2-IP TNL address relevant for its partner, for example, X2-C IP2 for PLMN-S1 is returned. It should be noted that when dedicated X2 IP addresses are defined per PLMN in shared eNB 450, certain embodiments facilitate the request for obtaining PLMN specific X2 IP addresses. This is done by denoting target TAI in the eNB configuration transfer message as “Target selected PLMN+TAC”.

In certain embodiments, upon receipt of TNL information of target eNB 450, source eNB 440 can setup the X2 link. The GU-Group ID information may also be shared between source eNB 440 and target eNB 450 as part of X2 setup. The source eNB 440 may use the PLMN ID, for example, PLMN-S1 derived using techniques described herein to evaluate X2 handover. Further, the GU-Group ID information may be used in source eNB 440 in order to determine if X2 handover is supported. If target eNB 450 does not belong to the same pool area of the source eNB 440, then S1 handover should be attempted. If X2 handover to target cell is allowed, then source eNB 440 may send handover request message to target eNB 450 with HRL which may indicate serving=S1 and EPLMN=D1. If S1 handover has to be used, then source eNB 440 may send handover required message to the MME with target PLMN based on S1, as derived.

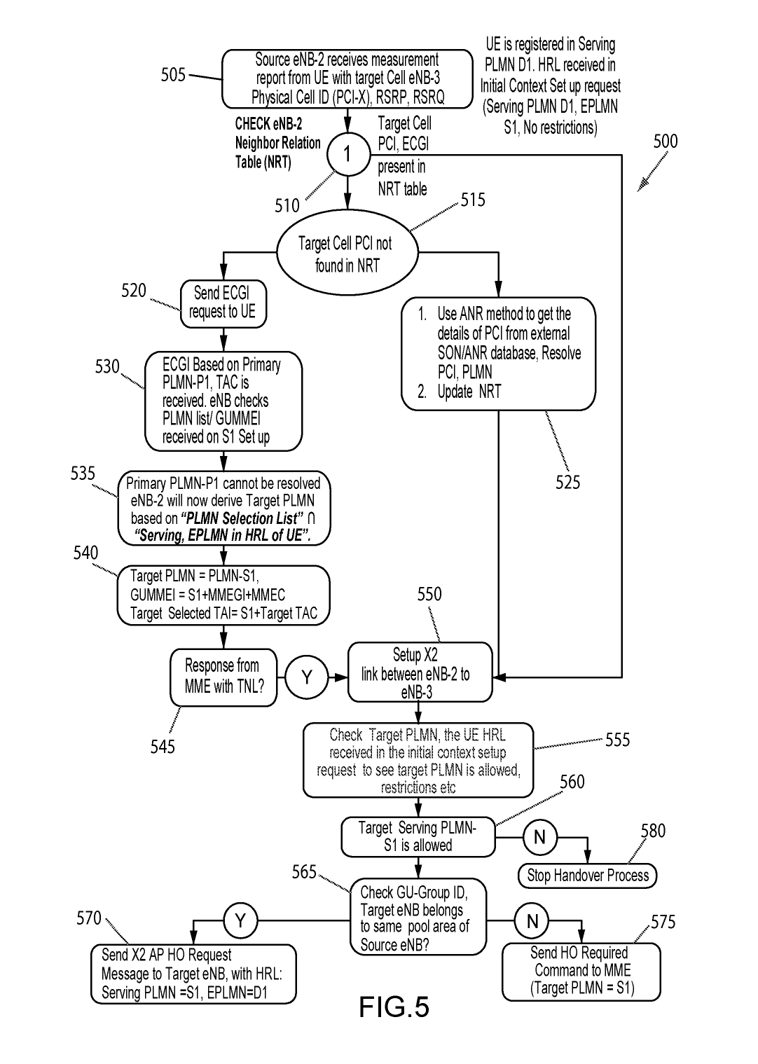

FIG. 5 illustrates a flowchart 500 of handover decision logic for a dedicated and a shared LTE network according to certain embodiments. UE 470 is registered in serving PLMN D1 and HRL is received in initial context set up request and may indicate the serving PLMN-D1, EPLMN-S1, no restrictions, etc.

Referring, in part, also to reference numerals in FIG. 4, at 505, source eNB 440 receives a measurement report from UE 470 with target cell's target eNB 450 physical cell ID (PCI-X), Radio Signal Receive Power (RSRP), and Reference Signal Received Quality (RSRQ). At 510, source eNB 440 is checked via neighbor relation table (NRT) for target cell PCI, ECGI being present in the NRT table. At 515, the target cell PCI is not found in the NRT. At 520, an ECGI request is sent to UE 470. At 525, an automatic neighbor relation (ANR) method is utilized to get the details of PCI from an external SON/ANR database to resolve PCI, PLMN. Next, the NRT is updated. At 530, an ECGI based on primary PLMN-P1, TAC is received and eNB checks the PLMN list/global unique mobility management entity (GUMMEI) received on 51 set up. At 535, primary PLMN-P1 cannot be resolved, so source eNB 440 determines a target PLMN based on a formulation of the intersection of “PLMN Selection List” and “Serving, EPLMN in HRL of UE”. At 540, target PLMN=PLMN S1, GUMMEI=S1+MMEGI+MMEC and target selected TAI=S1+target TAC, where MMEGI is mobility management entity group ID and MMEC is mobility management entity code. At 545, if there is a response from MME with transfer network layer (TNL), then at 550, an X2 link is setup between source eNB 440 to target eNB 450. At 555, the target PLMN is checked and the UE HRL is received in the initial context setup request is checked to see if target PLMN is allowed, restrictions, etc. At 560, if target serving PLMN-S1 is allowed then the logic proceeds to 565. Otherwise, at 580, the handover process is stopped. At 565, if the GU-Group ID and target eNB 450 belong to the same pool area of source eNB 440, then an X2 application protocol handover request message is sent to target eNB 450, with HRL serving PLMN=S1, EPLMN=D1, then the logic proceeds to 570. At 570, the GU-Group ID is checked to see whether target eNB 450 belongs to same pool area of source eNB 440. Otherwise, at 575, a handover required command is sent to MME, such as target PLMN=S1. S1 and X2 handover process may proceed as per 3GPP.

The use of the above logic can be selected by activating a parameter in the source eNB 440, for example, called “Target PLMN resolution parameter (Enable/Disable)”. When the above parameter is active, the source eNB 440 may resolve the primary PLMN in ECGI to PLMN ID obtained by intersection of PLMN selection list of target eNB 450 and PLMN supported in HRL which may indicate the serving PLMN-D1, EPLMN-S1, no restrictions, etc., otherwise the normal procedure as depicted in FIG. 1 may resume.

Certain embodiments focus on deriving the target PLMN for handover from a dedicated network to a shared network, that is, inter PLMN mobility support for networks that have a dedicated and a shared eUTRAN network based on different PLMN IDs.

The target PLMN thus selected as per certain embodiments is also used in selecting the correct: GUMMEI (MME) to route the eNB configuration transfer message; target selected TAI while composing the eNB configuration transfer message; source PLMN in the HRL for X2 handover; and target PLMN in S1 handover required message in case of S1 handover.

Certain embodiments include an implementation of an additional logic in the eNB, that would use UE specific HRL and the “Target PLMN Selection List” which is derived from PLMN list send by UE as part of ECGI reporting or PLMN list exchanged by eNBs as part of X2 set up between eNBs, to determine the target PLMN and target TAI for initiating the inter PLMN handover process. The target PLMN may also be used for selecting the correct MME for sending the eNB configuration transfer message associated with X2 TNL resolution.

The logic would make use of following information available with eNB: PLMN served by EPC (MME); PLMN list of target eNB received as part of ECGI reporting; PLMN list received as part of X2 setup; and HRL information associated with the UE, received as part of initial context set up or a previous handover message.

In certain embodiments, this use case is also applicable in a scenario in which a shared network operator may allocate dedicated X2-IP addresses for partner's network. If the target eNB has dedicated X2-IP address (X2-C IP1 for PLMN-P1 and X2-C IP2 for PLMN-S1) for its MOCN partner, the target selected TAI (S1+Target TAC) value composed by source eNB helps the target eNB to resolve the MME configuration transfer message to provide X2-IP TNL address relevant for its partner (X2-C IP2 for PLMN-S1 is returned).

In certain embodiments, the operator of a dedicated network may host multiple PLMNs, for example, multiple tenants with different PLMNs, in addition to PLMN-D1 there are PLMN-D2, PLMN-D3, etc. on the source eNB. All tenant PLMNs are defined as equivalent to PLMN-S1 broadcast on the shared network eNB. Certain embodiments can now be used to send tenant subscribers on shared network eNB to respective PLMNs on dedicated network eNB.

TABLE 2

| | | | HRL for the | |
|---|---|---|---|---|
| | ECGI Based | “PLMN | UE (Tenant | |
| | on Target | Selection | based on | Target PLMN = |
| Information | PLMN | List” on | PLMN-D2) | PLMN Selection |
| Source at | (i.e., Primary | Target | (Serving, | List ∩ Serving, |
| Target eNB | PLMN) | eNB | EPLMN) | EPLMN in HRL |
| Measurement | D1 | D1, D2 | D2, S1 | D2 |
| Report | | | | |
| X2 Setup | D1 | D1, D2 | D2, S1 | D2 |
| Procedure | | | | |

Table 2 above depicts in certain embodiments, how the target PLMN is resolved in a situation where a UE belonging to PLMN-D2 attempts to move from shared PLMN-S1 to PLMN-D2 on source eNB 440. It should be noted that the HRL for this UE while on PLMN-S1 is serving PLMN=>S1 and EPLMN=>D2.

Alternatively, as part of a separate handover decision logic, when a UE reports a ECGI with primary PLMN information that is not known at an initial eNB then the initial eNB checks if the broadcast PLMN list of other eNBs is available from ECGI measurement report. If the initial eNB finds a common PLMN within the broadcast list and HRL list of the UE, then the common PLMN is used as the target PLMN. However, if the broadcast PLMN list of the other eNBs is available from a previous X2 application protocol signaling between the eNBs, then the initial eNB finds a common PLMN within broadcast list and HRL list of the UE and the common PLMN is used as target PLMN. Otherwise, a target transport network layer (TNL) resolution is not allowed as a self-optimizing network (SON) eNB configuration transfer message cannot be routed to the target side of the shared LTE network. Further, a handover is not allowed due to the target PLMN resolution was not possible, leading to resort to a S1 handover.

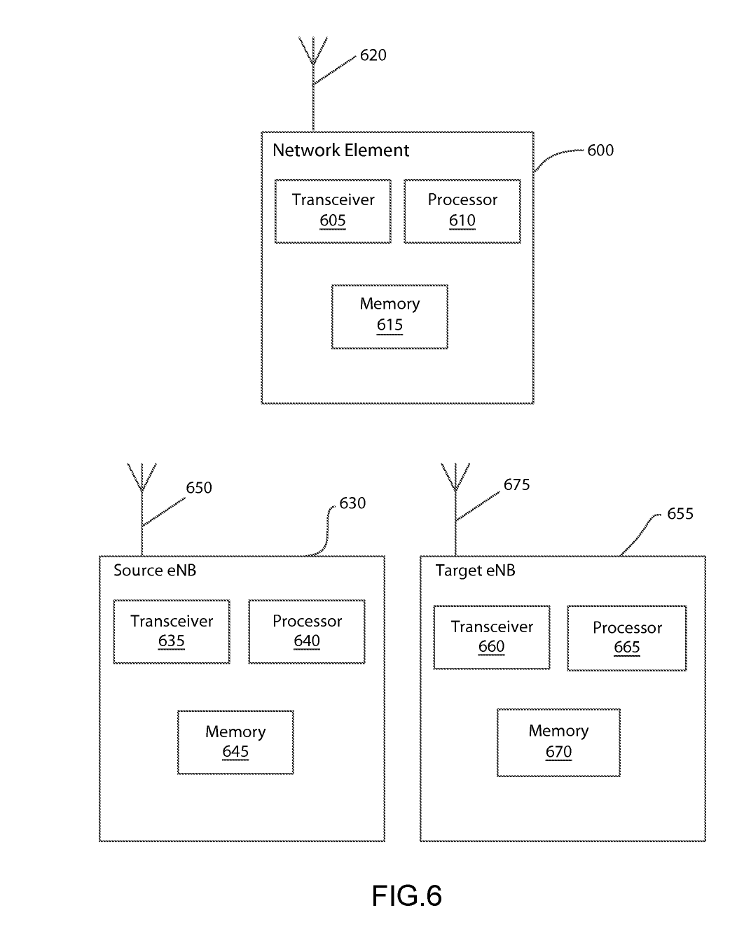

FIG. 6 illustrates a system according to certain embodiments. In one embodiment, a system may include several devices, such as, for example, network element 600, source eNB 630, and target eNB 655. Network element 600 may correspond to MMEs 120, 130, 410 and 420 or SGWs 110 and 140, as shown in FIGS. 1 and 4. Source eNB 630 may correspond to eNBs 160 and 440 and target eNB 655 may correspond to eNBs 170 and 450, as shown in FIGS. 1 and 4. The system may include more than one eNB, although only two eNBs are shown for the purposes of illustration.

Each of the devices in the system may include at least one processor, respectively indicated as 610, 640, and 665. At least one memory may be provided in each device, and indicated as 615, 645, and 670, respectively. The memory may include computer program instructions or computer code contained therein. One or more transceiver 605, 635, and 660 may be provided, and each device may also include an antenna, respectively illustrated as 620, 650, and 675. Although only one antenna each is shown, many antennas and multiple antenna elements may be provided to each of the devices. Other configurations of these devices, for example, may be provided. For example, network element 600, source eNB 630, and target eNB 655 may be additionally or solely configured for wired communication (not shown), and in such a case antennas 620, 650, and 675 may illustrate any form of communication hardware, without being limited to merely an antenna.

Transceivers 605, 635, and 660 may each, independently, be a transmitter, a receiver, or both a transmitter and a receiver, or a unit or device that may be configured both for transmission and reception.

Processors 610, 640, and 665 may be embodied by any computational or data processing device, such as a central processing unit (CPU), application specific integrated circuit (ASIC), or comparable device. The processors may be implemented as a single controller, or a plurality of controllers or processors.

Memories 615, 645, and 670 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and may be processed by the processors may be any suitable form of computer program code, for example, a compiled or interpreted computer program written in any suitable programming language.

The memory and the computer program instructions may be configured, with the processor for the particular device, to cause a hardware apparatus such as network element 600, source eNB 630, and target eNB 655, to perform any of the processes described above (see, for example, FIGS. 2, 3, and 5). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### LIST OF ABBREVIATIONS AND DEFINITIONS:

3G Third Generation

3GPP Third Generation Partnership Project for UMTS

3GPP2 Third Generation Partnership Project for CDMA 2000

ECGI Enhanced Cell Global Identity

eNB Evolved Node B

EPC Evolved Packet Core

EUTRAN Evolved UTRAN

GSM Global System for Mobile Communications

GUGI Global Unique Group ID

GUMMEI Global Unique Mobility Management Entity

HRL Handover Restriction List

LTE Long Term Evolution

MME Mobility Management Entity

MOCN Multi-Operator Core Network

PCI Physical Cell ID

SGW Serving Gateway

SON Self-optimizing Network

TAI Tracking Area Identity

TAC Tracking Area Code

TNL Transport Network Layer

We claim:

1. A method for handing over a user equipment from a serving base station in a dedicated network to a target base station in a shared network, the method comprising:
receiving, at the serving base station, a handover restriction list (HRL) comprising information on serving public land mobile networks (PLMN) and/or equivalent public land mobile networks (EPLMN) of the user equipment;
receiving a PLMN list comprising a plurality of PLMNs that are hosted by the target base station;
selecting a target PLMN for the user equipment using the HRL and the PLMN list, wherein the selected target PLMN is on the PLMN list but is not on the HRL; and
sending a handover request message indicating the selected target PLMN for the user equipment to the target base station.

2. The method of claim 1, further comprising:
mapping PLMNs between the PLMN selection list and the HRL for the selecting.

3. The method of claim 1, wherein the PLMN selection list is created in the serving base station.

4. The method of claim 3, wherein the PLMN selection list is created in the serving base station using PLMN information received as part of ECGI reporting or PLMN information received during an X2 link setup between the serving base station and the target base station.

5. The method of claim 3, further comprising:
selecting the target PLMN for the user equipment using intersection logic of the PLMN selection list and serving PLMN and/or one or more of EPLMNs as defined in the HRL for the user equipment.

6. The method of claim 5, wherein the intersection logic is represented by:
Target PLMN={(PLMN selection list of target base station)∩(serving PLMN, EPLMN, in HRL of user equipment)}.

7. The method of claim 5, further comprising:
selecting serving PLMN and/or EPLMNs as defined in the HRL for the user equipment if more than one target PLMNs values for the user equipment are derived from the intersection logic,
wherein if the more than one target PLMNs values are obtained, the intersection with serving PLMN in the HRL takes precedence.

8. The method of claim 5, wherein the intersection logic is used to tracking area identity information element (TAI IE) for self-optimizing network (SON) and associated SON procedures.

9. The method of claim 8, wherein transport network layer (TNL) information dedicated to specific PLMNs in shared configuration of the shared network is recovered using the SON procedures.

10. The method of claim 1, further comprising:
selectively enabling or disabling target PLMN resolution for mobility from the dedicated network to the shared network.

11. An apparatus for handing over a user equipment from a dedicated network to a target base station in a shared network, the apparatus comprising:
at least one processor; and
at least one memory including computer program code, wherein the at least one memory and the computer program code are configured to, with the at least one processor, cause the apparatus at least to
receive a handover restriction list (HRL) comprising information on serving public land mobile networks (PLMN) and/or equivalent public land mobile networks (EPLMN) of the user equipment;
receive a PLMN list comprising a plurality of PLMNs that are hosted by the target base station;
select a target PLMN for the user equipment using the HRL and the PLMN list, wherein the selected target PLMN is on the PLMN list but is not on the HRL; and
send a handover request message indicating the selected target PLMN for the user equipment to the target base station.

12. The apparatus of claim 11, where the memory and the computer program code are further configured, with the at least one processor, to cause the apparatus to map PLMNs between the PLMN selection list and the HRL for the selecting.

13. The apparatus of claim 11, wherein the PLMN selection list is created using PLMN information received as part of ECGI reporting or PLMN information received during an X2 link setup between the serving base station and the target base station.

14. The apparatus of claim 13, where the memory and the computer program code are further configured, with the at least one processor, to cause the apparatus to select the target PLMN for the user equipment using intersection logic of the PLMN selection list and serving PLMNs and/or EPLMNs as defined in the HRL for the user equipment.

15. The apparatus of claim 14, wherein the intersection logic is represented by:
Target PLMN={(PLMN selection list of target base station)∩(serving PLMN, EPLMN, in HRL of user equipment)}.

16. The apparatus of claim 14, where the memory and the computer program code are further configured, with the at least one processor, to cause the apparatus to select one of serving PLMNs and/or EPLMNs as defined in the HRL for the user equipment if more than one target PLMNs values for the user equipment are derived from the intersection logic,
wherein if the more than one target PLMNs values are obtained, the intersection with serving PLMN in the HRL takes precedence.

17. The apparatus of claim 14, wherein the intersection logic is used to tracking area identity information element (TAI IE) for self-optimizing network (SON) and associated SON procedures.

18. The apparatus of claim 17, wherein transport network layer (TNL) information dedicated to specific PLMNs in shared configuration of the shared network is recovered using the SON procedures.

19. The apparatus of claim 11, where the memory and the computer program code are further configured, with the at least one processor, to cause the apparatus to selectively enable or disable target PLMN resolution for mobility from the dedicated network to the shared network.

20. A computer program embodied on a computer-readable medium, the computer program configured to control a processor to perform operations comprising:
receiving, at a serving base station, a handover restriction list (HRL) comprising information on serving public land mobile networks (PLMN) and/or equivalent public land mobile networks (EPLMN) of a user equipment;
receiving a PLMN list comprising a plurality of PLMNs that are hosted by a target base station;
selecting a target PLMN for the user equipment using the HRL and the PLMN list, wherein the selected target PLMN is on the PLMN list but is not on the HRL; and
sending a handover request message indicating the selected target PLMN for the user equipment to the target base station.
